(19) United States
(12) Patent Application Publication
(10) Pub. No.: US 2026/0074992 A1
(43) Pub. Date: Mar. 12, 2026

(54) METHODS, SYSTEMS, AND DEVICES TO IMPLEMENT BIMODAL VPWS AND VPLS FORWARDING DOMAIN IN A LAYER 2 VIRUTAL PRIVATE NETWORK (L2VPN) NODE

(71) Applicant: CIENA CORPORATION, Hanover, MD (US)

(72) Inventors: David H Gilson, Honolulu, HI (US); Himanshu Shah, Hopkinton, MA (US); Marc Holness, Ottawa (CA)

(73) Assignee: CIENA CORPORATION, Hanover, MD (US)

(21) Appl. No.: 18/829,553

(22) Filed: Sep. 10, 2024

(51) Int. Cl. H04L 45/74; H04L 12/46; H04L 45/00

(52) U.S. Cl. CPC H04L 45/74; H04L 12/4641; H04L 45/38

(57) ABSTRACT

Aspects of the subject disclosure may include, for example, receiving first data via a first user-to-network interface (UNI) of a group of user-to-network interfaces (UNIs) from a first communication device, transferring the first data to a network-to-network interface (NNI) in response to receiving the first data from the first UNI, and receiving second data via the NNI from a second communication device. Further embodiments can include identifying a destination media access control (MAC) address associated with the second data, determining a second UNI of the group of UNIs based on the destination MAC address resulting in a first determination, and transferring the second data to the second UNI based on the first determination for transmitting to a third communication device. Other embodiments are disclosed.

### FIELD OF THE DISCLOSURE

The subject disclosure relates to methods, systems, and devices to implement bimodal VPWS and VPLS forwarding domain in a layer 2 virtual private network (L2VPN) node.

### BACKGROUND

In the current state of the art, an L2VPN node can utilize virtual private local area networking (LAN) services (VPLS) technology. In utilizing the VPLS technology, a L2 forwarding domain is instantiated in an L2VPN node. In the L2 forwarding domain, when data is received from an attachment circuit (AC) port and transfers the data to a pseudowire (PW), the media access control (MAC) source address is learned from the data (e.g., the data includes the MAC source address) and stored in a MAC address database. The MAC source address is associated with the AC port as a MAC destination in the MAC address database for subsequent look-ups based on MAC destination address. Further, when data is received from the PW in the L2 forwarding domain, a MAC lookup is performed. That is, the PW transfers the data by looking up the MAC destination address in the MAC address database and determining the AC port is associated with the MAC destination address in the MAC address database. If there is no association between an AC port and the MAC destination address in the MAC address database, then flooding is performed to determine the AC port associated with the MAC destination address. In VPLS, in each direction (e.g., from AC port to PW and from PW to AC port), both MAC source address learning and MAC destination address look-ups occur. That is, if the L2VPN node receives data from a communication device via the PW destined to a communication device via one of the AC ports, MAC source address learning is performed to associate the PW with the MAC address of the communication device. Further, if data is subsequently received via an AC port from another communication device, the destination MAC address is looked up in the MAC address database and if the PW is associated with the destination MAC address, the data is transferred to the PW accordingly. However, utilizing the VPLS has limitations. It can be challenging to scale the number of MAC addresses associated with the L2VPN node in the MAC address database due to the size (e.g., memory) limitations of the MAC address database. In addition, in the current state of the art, an L2VPN node can utilize virtual private wire service (VPWS) technology. In utilizing VPWS technology, L2 forwarding domain instantiated in a L2VPN node can receive data from one AC port and transfer the data to a PW without the need to perform an MAC lookup as the L2VPN node is configured to transfer any data received from that AC port to the PW accordingly. Further, if data is received from the PW, the L2VPN node can be configured to transfer the data to a specific AC port without any MAC lookup. One of the benefits of VPWS technology is that no MAC source address learning or MAC lookup on the L2VPN node is needed to transfer data. However, there is less flexibility in arranging point-to-point connections when utilizing VPWS in the L2VPN node. Less flexibility can mean that VPWS would require more point-to-point connections to provide connectivity among participating communication devices.

### BRIEF DESCRIPTION OF THE DRAWINGS

Reference will now be made to the accompanying drawings, which are not necessarily drawn to scale, and wherein:

FIGS. 1-2 are block diagrams illustrating exemplary, non-limiting embodiments of implementing bimodal VPWS and VPLS forwarding domains in accordance with various aspects described herein.

FIG. 3 depicts an illustrative embodiment of a method of implementing bimodal VPWS and VPLS forwarding domains in accordance with various aspects described herein.

FIG. 4 is a block diagram of an example, non-limiting embodiment of a computing environment in accordance with various aspects described herein.

### DETAILED DESCRIPTION

Unlike the current state of the art, one or more embodiments allows a layer 2 forwarding domain (virtual local area network (VLAN)) to be a mix of aspects of VPLS and aspects of VPWS where one direction can utilize a modified VPWS technology to take advantage of not having a limitation for scaling MAC addresses (e.g., incoming from a PW to an AC port in an L2VPN node) and the other direction can utilize a modified VPLS technology (e.g., incoming from an AC port to a PW) to take advantage of using a MAC address database with MAC source address-learning and flooding. Existing VPLS implementations today can try to emulate this behavior by turning off MAC source address-learning on a PW, however, the VPWS behavior from AC ports to PW is not fully achieved because MAC address-lookups are still performed, flooding may occur, and L2VPN node bandwidth issues can occur while trying to suppress such flooding.

One or more embodiments can include a bimodal VPWS and VPLS forwarding domain within a L2VPN node in which a modified VPWS technology is utilized in one traffic flow direction (e.g., AC port to PW) and a modified VPLS technology is utilized in the other traffic flow direction (e.g., PW to AC port) to take advantage of benefits of aspects of VPWS technology and aspects of VPLS technology while mitigating their disadvantages.

The subject disclosure describes, among other things, illustrative embodiments for receiving first data via a first user-to-network interface (UNI) (e.g., AC port) of a group of user-to-network interfaces (UNIs) from a first communication device, transferring the first data to a network-to-network interface (NNI) (e.g., PW) in response to receiving the first data from the first UNI, and receiving second data via the NNI from a second communication device. Further embodiments can include identifying a destination media access control (MAC) address associated with the second data, determining a second UNI of the group of UNIs based on the destination MAC address resulting in a first determination, and transferring the second data to the second UNI based on the first determination for transmitting to a third communication device. Other embodiments are described in the subject disclosure.

One or more aspects of the subject disclosure include a device, comprising a layer 2 virtual private network (L2VPN) node including a processor, and a memory that stores executable instructions that, when executed by the L2VPN node, facilitate performance of operations. The operations can comprise receiving first data via a first UNI of a group of UNIs port from a first communication device, transferring the first data to a NNI in response to receiving the first data from the first UNI, and receiving second data via the NNI from a second communication device. Further operations can comprise identifying a destination media access control (MAC) address associated with the second data, determining a second UNI of the group of UNIs based on the destination MAC address resulting in a first determination, and transferring the second data to the second UNI based on the first determination for transmitting to a third communication device.

One or more aspects of the subject disclosure include a method. The method can comprise receiving, by a layer 2 virtual private network (L2VPN) node including a processor, first data via a first UNI of a group of UNIs from a first communication device, transferring, by the L2VPN node, the first data to a NNI in response to receiving the first data from the first UNI, and receiving, by the L2VPN node, second data via the NNI from a second communication device. Further, the method can comprise identifying, by the L2VPN node, a destination media access control (MAC) address associated with the second data, determining, by the L2VPN node, a second UNI of the group of UNIs based on the destination MAC address resulting in a first determination. The determining of the second UNI comprises, prior to the determining of the second UNI, receiving third data via the second UNI, the third data comprises a source MAC address from a third communication device, determining that the source MAC address is not stored in a MAC address database, and storing the source MAC address in the MAC address database, and associating the source MAC address with the second UNI, wherein the source MAC address matches the destination MAC address. Further, the method comprises transferring, by the L2VPN node, the second data to the second UNI based on the first determination for transmitting to the third communication device.

One or more aspects of the subject disclosure include a non-transitory machine-readable medium, comprising executable instructions that, when executed by a layer 2 virtual private network (L2VPN) node including a processor, facilitate performance of operations. The operations can comprise receiving first data via a first UNI of a group of UNIs from a first communication device, transferring the first data to a NNI in response to receiving the first data from the first UNI, and receiving second data via the NNI from a second communication device, the second data includes a destination MAC address. Additional operations can comprise determining there is no UNI associated with the destination MAC address in the MAC address database, flooding the second data to the group of UNIs, receiving third data via a second UNI of the group of UNIs from a third communication device, the third data comprises a source MAC address associated with the third communication device. Also, the operations comprise determining the second UNI is associated with the MAC address of the third communication device resulting in a first determination, based on the first determination, associating the second UNI with the MAC address associated with the third communication device in a MAC address database. Further operations can comprise identifying the destination MAC address associated with the second data, determining the second UNI is associated with the destination MAC address based on a look-up in the MAC address database resulting in a second determination, and transferring the second data to the second UNI based on the second determination for transmitting to the third communication device.

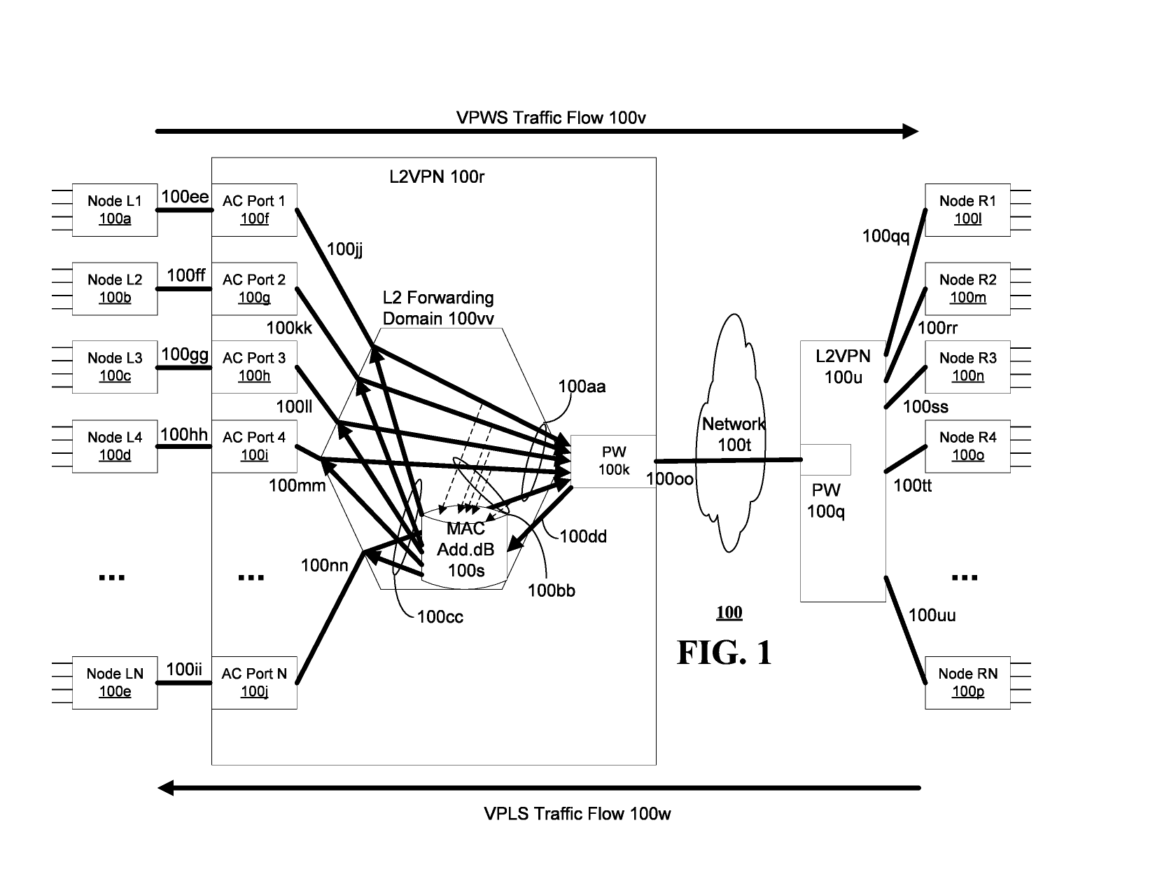

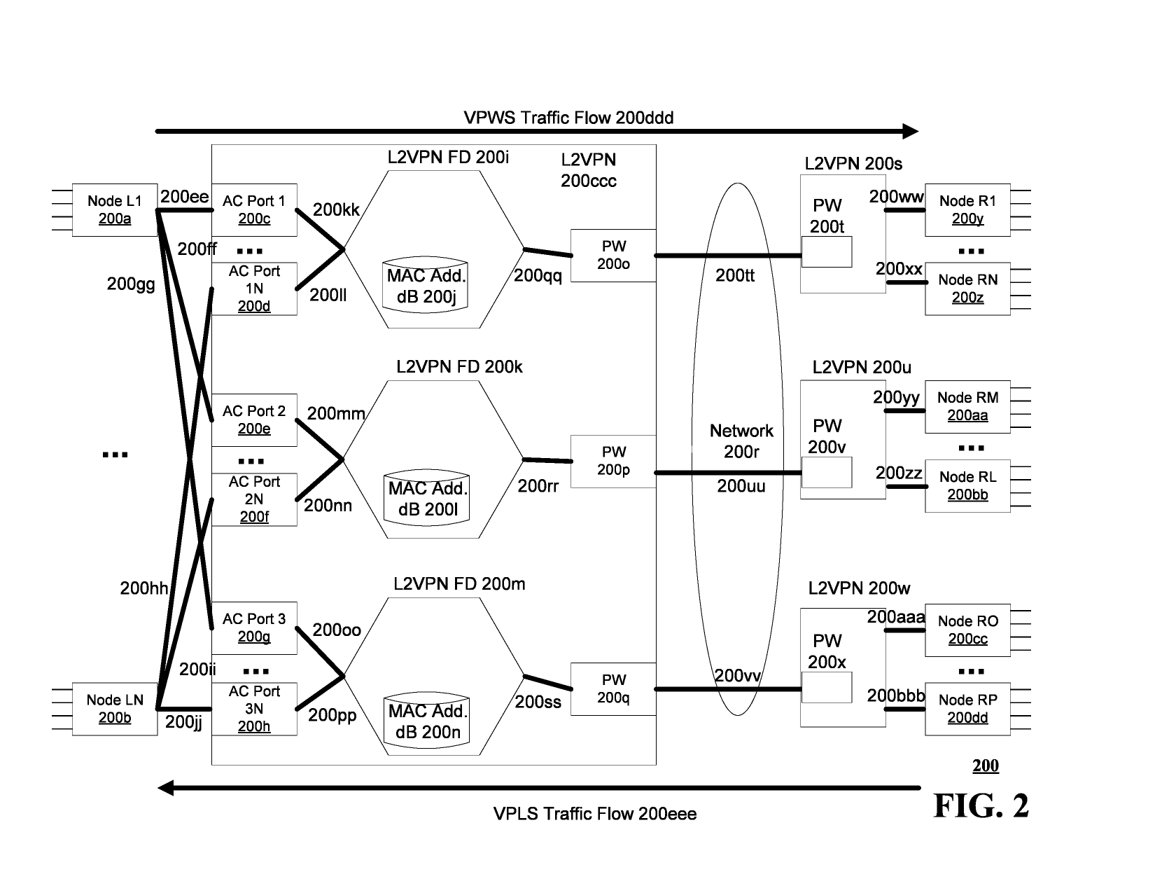

FIGS. 1-2 are block diagrams illustrating exemplary, non-limiting embodiments of implementing bimodal VPWS and VPLS forwarding domains in accordance with various aspects described herein.

One or more embodiments include, generally, an L2VPN node that has an L2 forwarding domain utilize modified VPWS technology in one direction and utilize modified VPLS technology in the other direction to take advantage of the functional aspects of both VPWS technology and VPLS technology. Particularly, an L2VPN node forwarding domain that comprises a NNI (e.g., pseudowire (PW)) and multiple UNIs (e.g., attachment circuit (AC) ports) can have the traffic flow direction of the NNI utilize VPWS whereby all the AC ports can transmit towards the NNI utilizing the modified VPWS technology. This allows for unlimited scale of destination MAC addresses for traffic flowing from UNIs to NNI. This also means that traffic arriving on the NNI does not learn the MAC source addresses as per VPWS technology. The same L2VPN node forwarding domain can have an opposite traffic flow direction from the NNI to the multiple UNIs utilizing the modified VPLS technology whereby MAC address database lookups can be performed for traffic from the NNI towards the UNIs and MAC source addresses are learned for traffic from UNIs and MAC address-lookup misses from MAC address database can cause flooding towards all NNIs as per VPLS technology.

Referring to FIG. 1, in one or more embodiments, system 100 can include a L2VPN node 100r. Further, system 100 can include node L1100a communicatively coupled to L2VPN node 100r over communication link 100ee via AC port 1100f, node L2100b communicatively coupled to L2VPN node 100r over communication link 100ff via AC port 2100g, node L3100c communicatively coupled to L2VPN node 100r over communication link 100gg via AC port 3100h, node L4100d communicatively coupled to L2VPN node 100r over communication link 100hh via AC port 4100i, and node LN 100e communicatively coupled to L2VPN node 100r over communication link 100ii via AC port N 100j. In addition, system 100 can include L2VPN node 100u communicatively coupled to L2VPN node 100r over communication link 100oo through communication network 100t via PW 100q on L2VPN node 100u and PW 100k on L2VPN node 100r. Also, system 100 can include node R1100l communicatively coupled to L2VPN node 100u over communication link 100qq via an AC port (not shown), node R2100m communicatively coupled to L2VPN node 100u over communication link 100rr via an AC port (not shown), node R3100n communicatively coupled to L2VPN node 100u over communication link 100ss via an AC port (not shown), node R4100o communicatively coupled to L2VPN node 100u over communication link 100tt via an AC port (not shown), and node RN 100p communicatively coupled to L2VPN node 100u over communication link 100uu via an AC port (not shown). A UNI can comprise an AC port and a NNI can comprise a PW.

In one or more embodiments, each of node L1100a, node L2100b, node L3100c, node L4100d, and node LN 100e, node R1100l, node R2100m, node R3 100n, node R4100o, and node RN 100p can comprise a network device. Further, each of node L1100a, node L2100b, node L3100c, node L4100d, and node LN 100e, node R1100l, node R2100m, node R3100n, node R4100o, and node RN 100p can be communicatively coupled to multiple communication devices. Each of these communication devices can be a network device, desktop computer, laptop computer, tablet computer, Internet of Things (IoT) device, mobile device, mobile phone, computing device, or any other communication device. Further, each of communication link 100ee, communication link 100ff, communication link 100gg, communication link 100hh, and communication link 100ii can be over a communication network. In addition, this communication network as well as communication network 100t can comprise one or more wired communication networks, wireless communication networks, or a combination thereof. Also, each of L2VPN node 100r and L2VPN node 100u can comprise one or more servers (or other computing device(s)) in one location, one or more servers spanning multiple locations, one or more virtual servers (instantiated on one or more servers or computing devices) in one location, one or more virtual servers spanning multiple locations, one or more cloud servers, or a combination thereof.

In one or more embodiments, the L2VPN node 100r can comprise a layer 2 (L2) forwarding domain 100vv. Further, the L2 forwarding domain 100vv can comprise a MAC address database (dB) 100s. In addition, the L2VPN node 100r implements a modified VPWS technology, as described herein, in the traffic flow 100v from the AC ports to the PW and implements a modified VPLS technology, as described herein, in the traffic flow 100w from the PW to the AC ports. That is, data received from AC port 1100f can be transferred to the L2 forwarding domain 100vv via communication link 100jj, data received from AC port 2100g can be transferred to the L2 forwarding domain 100vv via communication link 100kk, data received from AC port 3100h can be transferred to the L2 forwarding domain 100vv via communication link 100ll, data received from AC port 4100i can be transferred to the L2 forwarding domain 100vv via communication link 100mm, and data received from AC port N 100j can be transferred to the L2 forwarding domain 100vv via communication link 100nn. Further, according to the modified VPWS technology, any data received from each of AC port 1100f, AC port 2100g, AC port 3100h, AC port 4100i, and AC port N 100j are forwarded to PW 100k over communication links 100aa. In addition, each data can include source MAC address and the L2VPN node 100r can perform MAC source address learning and associate 100bb each source MAC address with its respective AC port and store the association in the MAC address database 100s.

In one or more embodiments, according to the modified VPLS technology, once data is received from the PW 100k, the L2VPN node 100r can determine the destination MAC address associated with the data. Further, the L2VPN node 100r can perform a lookup 100bb into the MAC address database 100s to determine the AC port associated with the destination MAC address. In addition, once the AC port is determined for each data received from the PW 100k based on its respective destination MAC address, the L2 forwarding domain 100vv transfers the respective data to each respective AC port over one of the communication links 100cc.

Referring to FIG. 2, in one or more embodiments, system 200 can include node L1200a communicatively coupled to L2VPN node 200ccc via AC port 1200c over communication link 200ee, node L1200a communicatively coupled to L2VPN node 200ccc via AC port 2200e over communication link 200ff, and node L1200a communicatively coupled to L2VPN node 200ccc via AC port 3200g over communication link 200gg. Further, system 200 can include node LN 200b communicatively coupled to L2VPN node 200ccc via AC port 1N 200d over communication link 200hh, node LN 200b communicatively coupled to L2VPN node 200ccc via AC port 2N 200f over communication link 200ii, and node LN 200b communicatively coupled to L2VPN node 200ccc via AC port 3N 200h over communication link 200jj.

In one or more embodiments, system 200 can include node R1200y communicatively coupled to L2VPN node 200s via communication link 200ww, node RN 200z communicatively coupled to L2VPN node 200s via communication link 200xx, node RM 200aa communicatively coupled to L2VPN node 200u via communication link 200yy, node RL 200bb communicatively coupled to L2VPN node 200u via communication link 200yy, node RO 200cc communicatively coupled to L2VPN node 200w via communication link 200aaa, and node RP 200dd communicatively coupled to L2VPN node 200w via communication link 200bbb. In addition, system 200 can include L2VPN node 200s is communicatively coupled to L2VPN node 200ccc via PW 200t and PW200o over communication link 200tt through communication network 200r, L2VPN node 200u is communicatively coupled to L2VPN node 200ccc via PW200v and PW 200p over communication link 200uu through communication network 200r, and L2VPN node 200w is communicatively coupled to L2VPN node 200ccc via PW 200x and PW 200q over communication link 200vv through communication network 200r. A UNI can comprise an AC port and a NNI can comprise a PW.

In one or more embodiments, L2VPN node 200ccc can comprise L2VPN forwarding domain (FD) 200i, L2VPN FD 200k, and L2VPN FD 200m. Further, L2VPN FD 200i can be associated with a MAC address dB 200j, L2VPN FD 200k can be associated with a MAC address dB 200l, and L2VPN FD 200m can be associated with a MAC address dB 200n. Each of L2VPN FD 200i, L2VPN FD 200k, and L2VPN FD 200m implement bimodal VPWS and VPLS. That is, each of L2VPN FD 200i, L2VPN FD 200k, and L2VPN FD 200m implement a modified VPWS technology, as described herein, in traffic flow 200ddd from the AC ports toward to PWs and implement a modified VPLS technology in traffic flow 200eee from the PWs toward the AC ports as described herein. Further, AC port 1200c is communicative coupled to L2VPN FD 200i via communication link 200kk, AC port 1N 200d is communicative coupled to L2VPN FD 200i via communication link 200ll, AC port 2200e is communicative coupled to L2VPN FD 200k via communication link 200mm, AC port 2N 200f is communicative coupled to L2VPN FD 200k via communication link 200nn, AC port 3200g is communicative coupled to L2VPN FD 200m via communication link 200oo, and AC port 3N 200h is communicative coupled to L2VPN FD 200m via communication link 200pp. In addition, PW 200o is communicatively coupled to L2VPN FD 200i via communication link 200qq, PW200p is communicatively coupled to L2VPN FD 200k via communication link 200rr, and PW 200q is communicatively coupled to L2VPN FD 200m via communication link 200ss.

In one or more embodiments, each of node L1200a, node LN 200b, node R1200y, node RN 200z, node RM 200aa, node RL 200bb, node RO 200cc, and RP 200dd can comprise network devices and can be communicatively coupled to multiple communication devices. Each of these communication devices can be a network device, desktop computer, laptop computer, tablet computer, Internet of Things (IoT) device, mobile device, mobile phone, computing device, or any other communication device. Further, each of communication link 200ee, communication link 200ff, communication link 200gg, communication link 200hh, communication link 200ii, and 200jj can be over a communication network. In addition, this communication network as well as communication network 200r can comprise one or more wired communication networks, wireless communication networks, or a combination thereof. Also, each of L2VPN node 200ccc, L2VPN node 200s, L2VPN node 200u, and L2VPN node 200w can comprise one or more servers (or other computing devices(s)) in one location, one or more servers spanning multiple locations, one or more virtual servers (instantiated on one or more servers or computing devices) in one location, one or more virtual servers spanning multiple locations, one or more cloud servers, or a combination thereof.

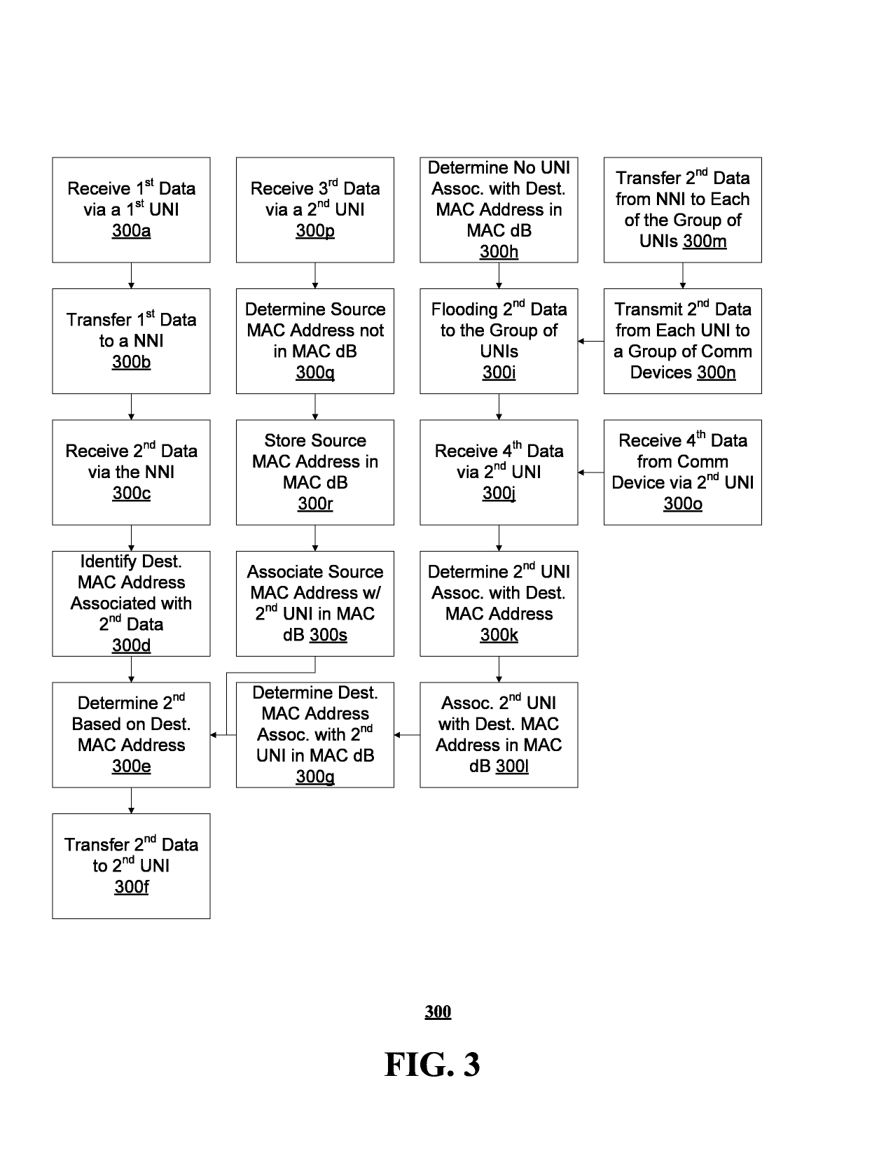

FIG. 3 depicts an illustrative embodiment of a method 300 of implementing bimodal VPWS and VPLS forwarding domains in accordance with various aspects described herein. In one or more embodiments, aspects of the method can be implemented by a L2VPN node. Method 300 can include the L2VPN node, at 300a, receiving first data via a first UNI of a group of UNIs from a first communication device. Further, the method 300 can include the L2VPN node, at 300b, transferring the first data to a NNI in response to receiving the first data from the first UNI. In addition, the method 300 can include the L2VPN node, at 300c, receiving second data via the NNI from a second communication device. Also, the method 300 can include the L2VPN node, at 300d, identifying a destination media access control (MAC) address associated with the second data. Further, the method 300 can include the L2VPN node, at 300e, determining a second UNI of the group of UNIs based on the destination MAC address resulting in a first determination. In addition, the method 300 can include the L2VPN node, at 300f, transferring the second data to the second UNI based on the first determination for transmitting to a third communication device. The transferring of the first data to the NNI comprises transferring the first data to the NNI utilizing a modified virtual private wire service (VPWS) technology, as described herein. The transferring of the second data to the second UNI comprises transferring the second data to the second port utilizing a modified virtual private local area networking (LAN) services (VPLS) technology, as described herein.

In one or more embodiments, the method 300 can include the L2VPN node, at 300g, determining the destination MAC address is associated with second UNI in a MAC address database. In some embodiments, the determining of the second UNI comprises determining the destination MAC address is associated with second UNI in a MAC address database.

In one or more embodiments, the method 300 can include the L2VPN node, prior to determining the second UNI, at 300p, receiving third data via the second UNI. The third data comprises a source MAC address from the third communication device. Further, the method 300 can include the L2VPN node, at 300q, determining that the source MAC address is not stored in a MAC address database. In addition, the method 300 can include the L2VPN node, at 300r, storing the source MAC address in the MAC address database. Also, the method 300 can include the L2VPN node, at 300s, associating the source MAC address with the second UNI. The source MAC address matches the destination MAC address.

In one or more embodiments, the method 300 can include the L2VPN node, prior to determining the second UNI, at 300h, determining that there is no UNI associated with the destination MAC address in the MAC address database. Further, the method 300 can include the L2VPN node, at 300i, flooding the second data to the group of UNIs. In addition, the method 300 can include the L2VPN node, at 300j, receiving fourth data via the second UNI from the third communication device. Also, the method 300 can include the L2VPN node, at 300k, determining the second UNI is associated with the destination MAC address based on the fourth data resulting in a second determination. Further, the method 300 can include the L2VPN node, at 300l, associating the second UNI with the destination MAC address in the MAC address database based on the second determination.

In one or more embodiments, the method 300 can include the L2VPN node, at 300m, transferring the second data from the NNI to each UNI of the group of UNIs. Further, the method 300 can include the L2VPN node, at 300n, transmitting the second data from each UNI of the group of UNIs to a group of communication devices. In some embodiments, the flooding of the second data comprises transferring the second data from the NNI to each UNI of the group of UNIs, and transmitting the second data from each UNI of the group of UNIs to a group of communication devices that includes the third communication device. In addition, the method 300 can include the L2VPN node, at 300o, receiving the fourth data from the third communication device of the group of communication devices via the second UNI.

In one or more embodiments, each UNI of the group of UNIs comprises an attachment circuit (AC) port and the NNI comprises a PW. The communication device is associated with the destination MAC address. The L2VPN node implements bimodal VPWS and VPLS. That is, a modified VPWS technology is implemented in a first traffic flow direction from the first UNI to the NNI and a modified VPLS technology is implemented in a second traffic flow direction from NNI to the first UNI.

Note, there is no SA learning from NNI to UNI traffic direction.

While for purposes of simplicity of explanation, the respective processes are shown and described as a series of blocks in FIG. 3, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein. One or more blocks can be performed in response to one or more other blocks.

Portions of some embodiments can be combined with portions of other embodiments.

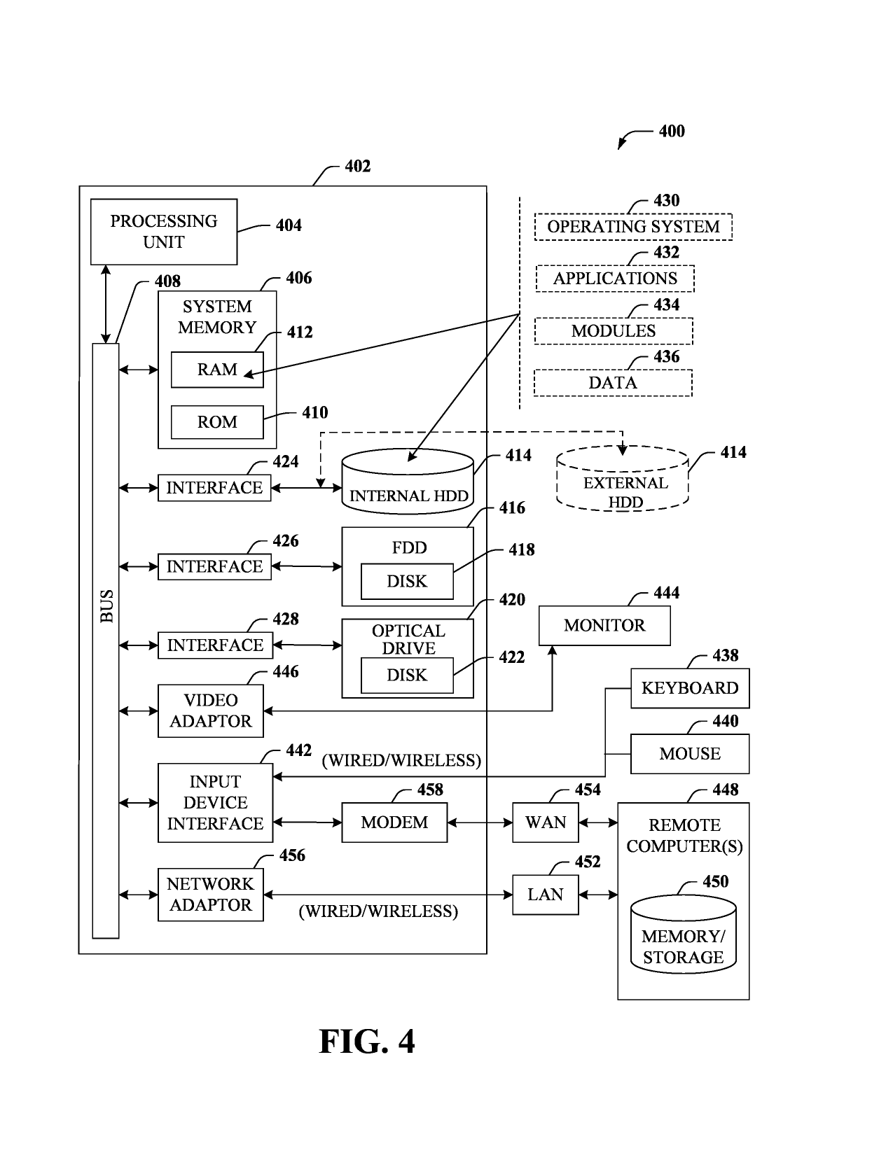

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. For example, computing environment 400 can facilitate in whole or in part implement bimodal VPWS and VPLS forwarding domain in a L2VPN node. Further, each of node L1100a, node L2100b, node L3 100c, node L4 100d, node LN 100e, L2VPN node 100r, L2VPN node 100u, node R1100l, node R2100m, node R3100n, node R4100o, node RN 100p, node L1200a, node LN 200b, L2VPN node 200ccc, L2VPN node 200s, L2VPN node 200u, L2VPN node 200w, node R1 200v, node RN 200z, node RM 200aa, node RL 200bb, node RO 200cc, and node RP 200dd can comprise computing environment 400.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM),flash memory or other memory technology, compact disk read only memory (CD ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data. Computer-readable storage media can comprise the widest variety of storage media including tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a layer 2 virtual private network (L2VPN) node including a processor; and
a memory that stores executable instructions that, when executed by the L2VPN node, facilitate performance of operations, the operations comprising:
receiving first data via a first user-to-network interface (UNI) of a group of user-to-network interfaces (UNIs) from a first communication device;
transferring the first data to a network-to-network interface (NNI) in response to receiving the first data from the first UNI;
receiving second data via the NNI from a second communication device;
identifying a destination media access control (MAC) address associated with the second data;
determining a second UNI of the group of UNIs based on the destination MAC address resulting in a first determination; and
transferring the second data to the second UNI based on the first determination for transmitting to a third communication device.

2. The device of claim 1, wherein the transferring the first data to the NNI comprises transferring the first data to the NNI utilizing a modified virtual private wire service (VPWS) technology, wherein the transferring the second data to the second UNI comprises transferring the second data to the second UNI utilizing a modified virtual private local area networking (LAN) services (VPLS) technology.

3. The device of claim 1, wherein the operations comprise:
prior to determining the second UNI, receiving third data via the second UNI, wherein the third data comprises a source MAC address from the third communication device;
determining that the source MAC address is not stored in a MAC address database;
storing the source MAC address in the MAC address database; and
associating the source MAC address with the second UNI, wherein the source MAC address matches the destination MAC address.

4. The device of claim 1, wherein the determining of the second UNI comprises determining the destination MAC address is associated with second UNI in a MAC address database.

5. The device of claim 4, wherein the operations comprise:
prior to determining the second UNI, determining that there is no UNI associated with the destination MAC address in the MAC address database; and
flooding the second data to the group of UNIs.

6. The device of claim 5, wherein the flooding of the second data comprises:
transferring the second data from the NNI to each UNI of the group of UNIs; and
transmitting the second data from each UNI of the group of UNIs to a group of communication devices that includes the third communication device.

7. The device of claim 6, wherein each UNI of the group of UNIs comprises an attachment circuit (AC) port, wherein the NNI comprises a pseudowire (PW).

8. The device of claim 6, wherein the third communication device comprises a mobile phone.

9. The device of claim 1, wherein the third communication device is associated with the destination MAC address.

10. The device of claim 1, wherein the L2VPN node implements bimodal VPWS and VPLS.

11. The device of claim 1, wherein a modified VPWS technology is implemented in a first traffic flow direction from the first UNI to the NNI.

12. The device of claim 1, wherein a modified VPLS technology is implemented in a second traffic flow direction from NNI to the first UNI.

13. A method, comprising:
receiving, by a layer 2 virtual private network (L2VPN) node including a processor, first data via a first user-to-network interface (UNI) of a group of user-to-network interfaces (UNIs) from a first communication device;
transferring, by the L2VPN node, the first data to a network-to-network interface (NNI) in response to receiving the first data from the first UNI;
receiving, by the L2VPN node, second data via the NNI from a second communication device;
identifying, by the L2VPN node, a destination media access control (MAC) address associated with the second data;
determining, by the L2VPN node, a second UNI of the group of UNIs based on the destination MAC address resulting in a first determination, wherein the determining of the second UNI comprises:
prior to the determining of the second UNI, receiving third data via the second UNI, wherein the third data comprises a source MAC address from a third communication device;
determining that the source MAC address is not stored in a MAC address database;
storing the source MAC address in the MAC address database; and
associating the source MAC address with the second UNI, wherein the source MAC address matches the destination MAC address; and
transferring, by the L2VPN node, the second data to the second UNI based on the first determination for transmitting to third communication device.

14. The method of claim 13, wherein the determining of the second UNI comprises determining, by the L2VPN node, the destination MAC address is associated with second UNI in the MAC address database.

15. The method of claim 14, comprising:
prior to determining the second UNI, determining, by the L2VPN node, that there is no UNI associated with the destination MAC address in the MAC address database; and
flooding, by the L2VPN node, the second data to a group of UNIs.

16. The method of claim 15, wherein the flooding of the second data comprises:
transferring, by the L2VPN node, the second data from the NNI to each UNI of the group of UNIs; and
transmitting, by the L2VPN node, the second data from each UNI of the group of UNIs to a group of communication devices that includes the third communication device.

17. The method of claim 16, wherein each UNI of the group of UNIs comprises an attachment circuit (AC) port, wherein the NNI comprises a pseudowire (PW).

18. The method of claim 16, wherein the third communication device comprises a mobile phone.

19. The method of claim 13, wherein the third communication device is associated with the destination MAC address.

20. A non-transitory machine-readable medium, comprising executable instructions that, when executed by a layer 2 virtual private network (L2VPN) node including a processor, facilitate performance of operations, the operations comprising:
receiving first data via a first user-to-network interface (UNI) of a group of user-to-network interfaces (UNIs) from a first communication device;
transferring the first data to a network-to-network interface (NNI) in response to receiving the first data from the first UNI;
receiving second data via the NNI from a second communication device, wherein the second data includes a destination MAC address;
determining there is no UNI associated with the destination MAC address in the MAC address database;
flooding the second data to the group of UNIs;
receiving third data via a second UNI of the group of UNIs from a third communication device, wherein the third data comprises a source MAC address associated with the third communication device;
determining the second UNI is associated with the source MAC address of the third communication device resulting in a first determination; and
based on the first determination, associating the second UNI with the source MAC address associated with the third communication device in a MAC address database.
